(19) United States
(12) Patent Application Publication
(10) Pub. No.: US 2012/0082573 A1
(43) Pub. Date: Apr. 5, 2012

(54) ALUMINUM WOUND LINE-START BRUSHLESS PERMANENT MAGNET MOTOR

(76) Inventors: Vincent Fargo, St. Charles, MO (US); Pingshan Cao, Jiangsu (CN); Xin Li, Jiangsu (CN); Jie Yi, Jiangsu (CN)

(21) Appl. No.: 13/243,232

(22) Filed: Sep. 23, 2011

(30) Foreign Application Priority Data
Sep. 30, 2010 (CN) 201010537956.7

(51) Int. Cl. H02K 21/46; H02K 15/00; F04B 17/03

(52) U.S. Cl. 417/410.1; 310/156.78; 29/596

(57) ABSTRACT

A line-start brushless permanent magnet motor assembly includes an unconventional combination of a rotor assembly including a plurality of permanent magnets mounted thereon, and a stator assembly including aluminum winding coils. The unique combination of construction features leads to significant motor performance enhancements at lower incremental cost. The line-start brushless permanent magnet motor assembly may be incorporated into a hermetic compressor, such as may be used in an air conditioning system, to meet high efficiency standards (e.g., seasonal efficiency energy rating). The disclosed embodiments have an efficiency of at least 90% with winding coils consisting essentially entirely of aluminum.

### CROSS-REFERENCE TO RELATED APPLICATION

This application claims the benefit and priority of Chinese Application No. 201010537956.7 filed Sep. 30, 2010, the entire disclosure of which is incorporated herein by reference.

### BACKGROUND OF THE INVENTION

1. Field of the Invention

The present invention relates generally to an electric motor assembly. More specifically, the present invention concerns a line-start brushless permanent magnet motor assembly that includes a rotor assembly with a plurality of permanent magnets mounted thereon, and a stator assembly with aluminum winding coils.

2. Discussion of the Prior Art

Those of ordinary skill in the art will appreciate that electric motors are known to be generally effective and are commonly used in a variety of industrial applications. For example, electric motors may be incorporated into compressors, such as may be used in air conditioning systems, to drive a compressing mechanism. Those of ordinary skill in the art will also appreciate that line-start brushless permanent magnet motor technology has been used effectively to increase motor efficiency and/or compressor performance.

Conventionally, the addition of permanent magnets to rotors for line-start brushless permanent magnet motors has yielded increased efficiency as the permanent magnets lower rotor losses, with such losses decreasing to almost zero at full speed (due to synchronization between the rotor and the magnetic field of the stator). The relatively high material costs associated with the powerful permanent magnets used in such rotors to achieve synchronization, however, has been detrimental, and may push this technology out of reach for many potential customers. Thus, line-start brushless permanent magnet motors have historically come with a significantly increased cost in order to achieve the improved performance offered thereby.

The correspondence between high efficiency and high cost, therefore, has made traditional line-start brushless permanent magnet motors a premium category of motors, designed with maximum performance in mind. As will be readily appreciated by one of ordinary skill in the art, the required permanent magnets for the rotor add significant material cost to an otherwise typical induction motor. Accordingly, conventional design of prior art line-start brushless permanent magnet motors has consistently taught that the high-cost, high-grade permanent magnets of the rotor be paired with correspondingly high-cost, high-grade copper windings of the stator.

### SUMMARY

The present invention provides a line-start brushless permanent magnet motor assembly that includes an unconventional combination of a rotor assembly with a plurality of permanent magnets, and a stator assembly with aluminum windings. The unique combination of construction features leads to significant motor performance enhancements at considerably lower incremental cost than has been realized by prior art line-start brushless permanent magnet motors.

More specifically, it has been unexpectedly determined that a new line-start brushless permanent magnet motor with windings formed of aluminum (a material not ordinarily used in windings for high-performance motors) exhibited only a slight performance difference compared to a prior art line-start brushless permanent magnet motor with traditional copper windings. Simultaneously, the aluminum material used in the new line-start brushless permanent magnet motor offset a considerable portion of the material cost of the permanent magnets. In one embodiment, a new line-start brushless permanent magnet motor with windings formed of aluminum demonstrated a motor efficiency of approximately 94%, whereas a prior art line-start brushless permanent magnet motor with windings formed of copper demonstrated only a slightly higher motor efficiency of approximately 95%.

According to one aspect of the present invention, a line-start brushless permanent magnet motor assembly is provided. The motor assembly includes a rotor assembly rotatable about an axis. The rotor assembly includes a rotor core body and a plurality of permanent magnets mounted on the rotor core body. The permanent magnets extend generally axially along the rotor core body. The motor assembly further includes a stator assembly spaced radially away from the rotor assembly. The stator assembly includes a stator core body that presents a plurality of circumferentially spaced axial slots and defines a central bore for receiving the rotor assembly. The stator assembly further includes electrically conductive winding coils that are received within and distributed generally across multiple ones of the axial slots of the stator core body, wherein the winding coils comprise aluminum.

According to another aspect of the present invention, in a line-start brushless permanent magnet motor assembly that includes a rotor rotatable about an axis and a stator spaced radially away from the rotor, wherein the stator presents a plurality of circumferentially spaced axial slots for receiving winding coils and defines a central bore for receiving the rotor, the improvement includes combining a plurality of permanent magnets disposed within the rotor with the winding coils of the stator comprising aluminum. The permanent magnets extend generally axially along the rotor to be disposed generally parallel to the axis. The aluminum winding coils are received within and distributed generally across multiple ones of the axial slots of the stator core body.

Another aspect of the present invention concerns a method of delivering increased motor efficiency at lower incremental cost. The method includes the step of providing a plurality of permanent magnets within a rotor, with the permanent magnets extending generally axially along the rotor. The method also includes the steps of forming winding coils from aluminum for receipt within a plurality of circumferentially spaced axial slots of a stator, and disposing the rotor within a central bore of the stator to form an aluminum wound, line-start, brushless, permanent magnet motor, wherein the motor has an efficiency of at least about 90%.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is an isometric view of a line-start brushless permanent magnet motor assembly constructed in accordance with the principles of an embodiment of the present invention, illustrating a rotor assembly and a stator assembly, schematically depicting aluminum winding coils of the stator assembly;

FIG. 2 is a sectional view of the line-start brushless permanent magnet motor assembly, taken approximately through the middle of the motor assembly of FIG. 1, depicting internal details of construction of the rotor assembly, including a plurality of permanent magnets disposed therein;

FIG. 3 is an isometric view of a digital compressor assembly configured to provide variable capacity modulation, with a compressing mechanism and a driving mechanism including the line-start brushless permanent magnet motor assembly disposed therein; and

FIG. 4 is a sectional view of the digital compressor assembly, taken approximately through the middle of the compressor assembly of FIG. 3, depicting internal details of construction of the compressing mechanism including first and second mechanical elements, and of the driving mechanism including the rotor and stator assemblies of the line-start brushless permanent magnet motor.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

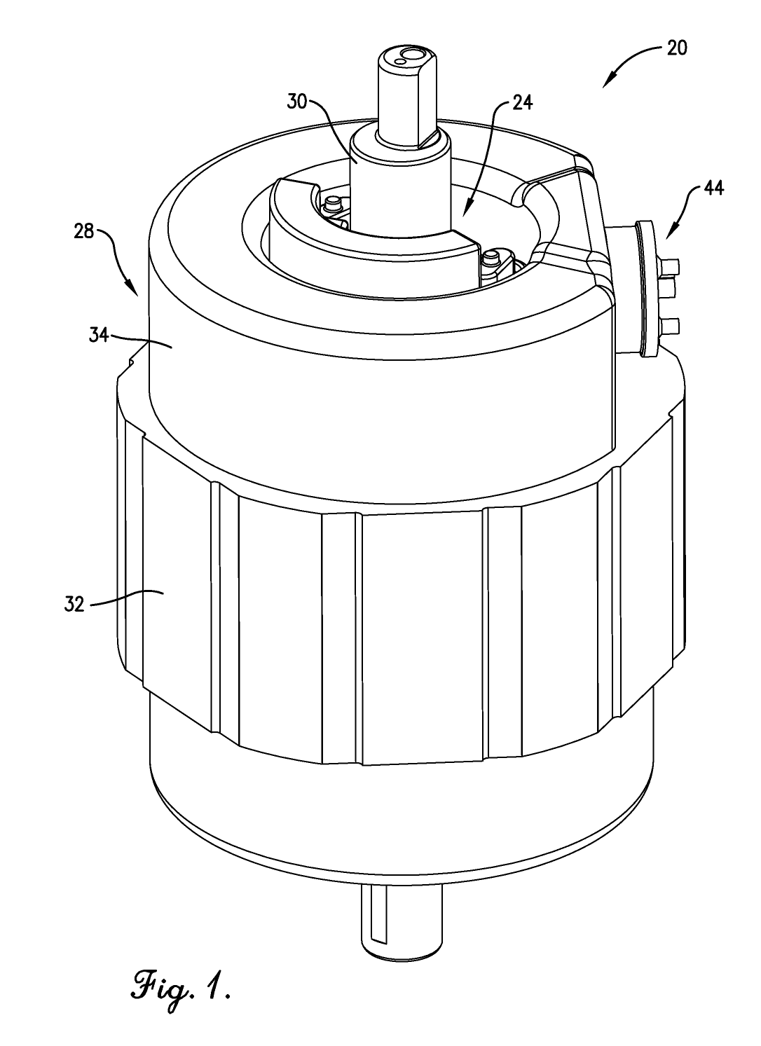

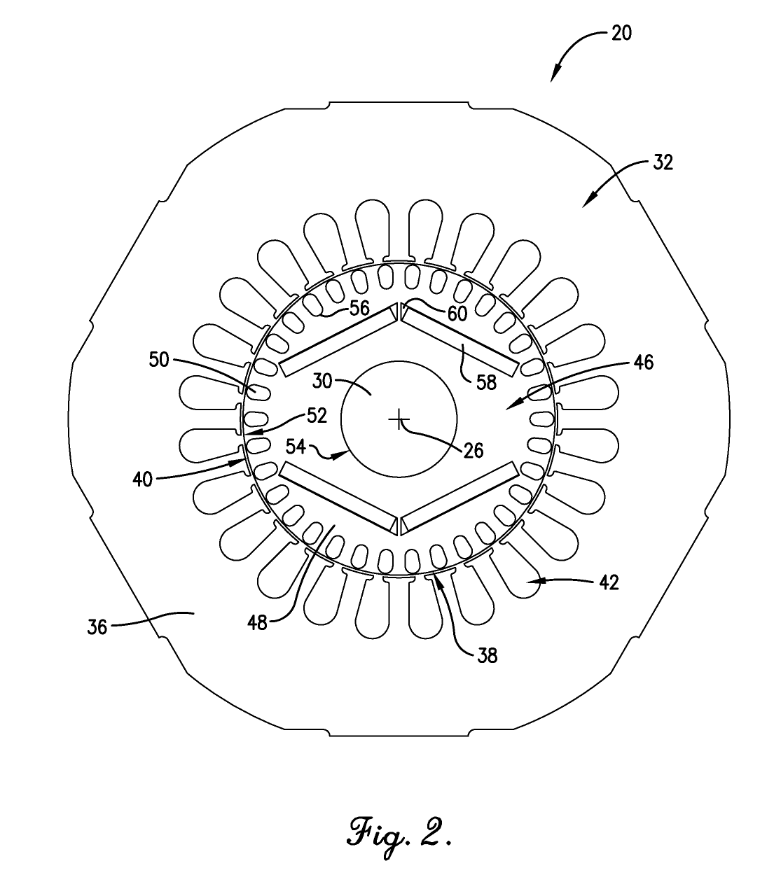

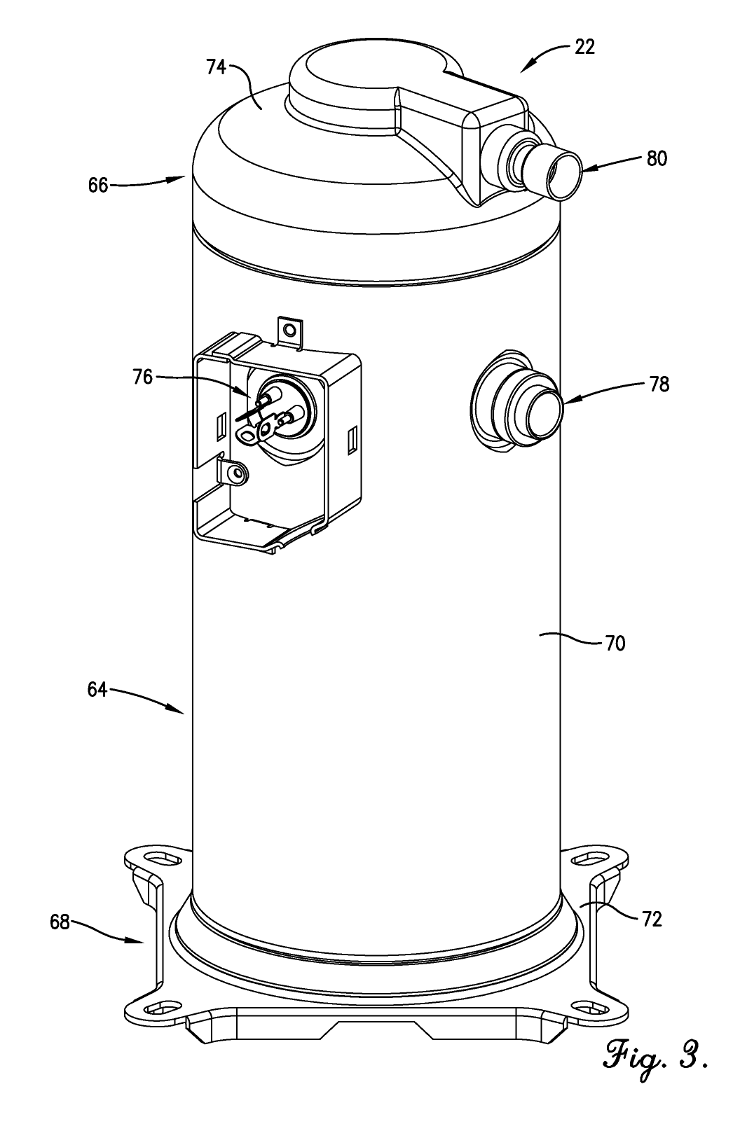

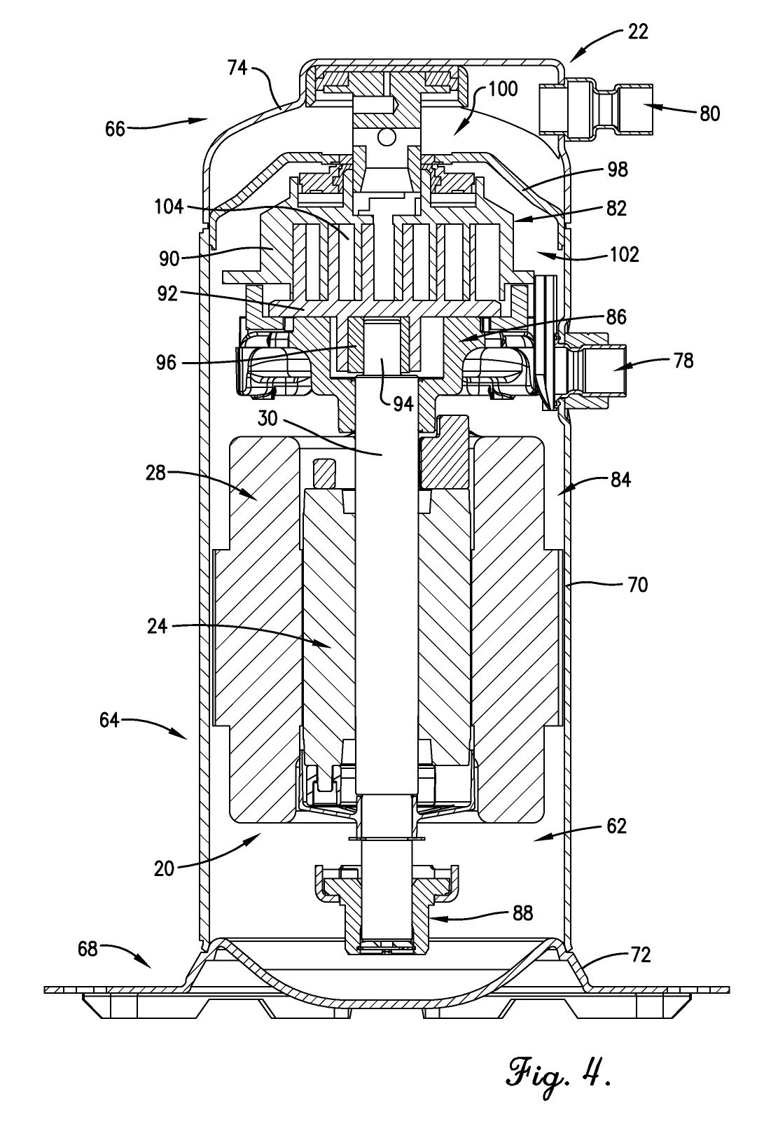

With initial reference to FIGS. 1-2, a line-start brushless permanent magnet motor assembly 20 constructed in accordance with the principles of an embodiment of the present invention is depicted for use in various applications. While the motor assembly 20 is useful in various applications, the illustrated embodiment has particular utility when the motor assembly 20 is configured to drive a hermetic compressor of the scroll, rotary, or piston type. More specifically, the motor assembly 20 is notably advantageous when the motor assembly 20 is disposed within a compressor assembly 22 (see FIGS. 3-4) as described in detail below.

As is somewhat customary, the motor assembly 20 broadly includes a rotor assembly 24, which is rotatable about an axis 26, and a stator assembly 28. The rotor assembly 24 and the stator assembly 28 may both be generally contained within an internal motor chamber of a motor case (not shown in FIGS. 1-2), as will be readily appreciated by one of ordinary skill in the art. The rotor assembly 24 includes an axially disposed shaft 30 that is configured for rotation with the rotor assembly 24 and that projects axially outwardly from both ends of the stator assembly 28. While only one exemplary embodiment is depicted here, of course alternative arrangements of suitable rotor and stator assemblies are contemplated and are clearly within the ambit of the present invention.

As will be readily appreciated by one of ordinary skill in the art upon review of this disclosure, various other general motor components (not shown) may be included within the motor assembly 20 without departing from the teachings of the present invention. It is noted that such components are typically substantially conventional in nature, although aspects may take slightly modified forms, often depending upon the particular intended use of the motor assembly 20. Any modifications to generally conventional motor components that are not depicted or described in detail herein are not intended to impact the scope of the present invention, which is defined exclusively by the claims.

Turning briefly now to construction details of the stator assembly 28, one of ordinary skill in the art will readily understand that the stator assembly 28 depicted in FIGS. 1-2 broadly includes a stator core body 32 and a generally axially concentric winding 34. The illustrated stator core body 32 is comprised of a plurality of axially stacked stator laminations 36 (see FIG. 2), as is generally known in the art. It is noted that the winding 34 depicted in FIG. 1 is shown in a conventional schematic form, but that additional details regarding the winding 34 are described below. As will be readily appreciated by one of ordinary skill in the art, the particular configuration of the winding 34 may directly impact the power, torque, voltage, operational speed, number of poles, etc. of the motor assembly 20.

As is somewhat conventional in the art, each individual stator lamination 36 includes a substantially annular steel body, such that the plurality of axially stacked stator laminations 36 forming the stator core body 32 cooperatively presents a generally central axial bore 38 for receiving the rotor assembly 24. As will be readily understood by one of ordinary skill in the art, an air gap 40 extends radially between the stator core body 32 of the stator assembly 28 and the rotor assembly 24, such that the rotor assembly 24 is able to rotate freely within the stator assembly 28.

The plurality of axially stacked stator laminations 36 forming the stator core body 32 also cooperatively presents a plurality of generally arcuate slots 42 extending axially therethrough, with each depicted slot 42 being in communication with the air gap 40. As will be readily understood by one of ordinary skill in the art, electrically conductive wires make up the winding 34, which passes through the slots 42 for receipt therein. It is noted that in the illustrated embodiment, the stator core body 32 of the stator assembly 28 includes twenty-four slots 42, although various numbers of slots may be alternatively provided without departing from the teachings of the present invention.

The motor assembly 20 of the depicted embodiment is configured as a three-phase motor. Shifting briefly now to operation considerations of three-phase motors, and to details of the windings used therein, one of ordinary skill in the art will readily appreciate that three-phase electric motors are commonly used in a variety of industrial applications (such as to drive pumps, fans, blowers, compressors, and the like). As is generally known, a three-phase motor is often more compact and can be less costly than a single-phase motor of the same voltage class and duty rating. In addition, many three-phase motors often exhibit less vibration and may therefore last longer than corresponding single-phase motors of the same power used under the same conditions. The principles of the present invention, however, are not limited to a three-phase motor, but also apply with equal force to a single-phase motor (not shown). In more detail, the motor assembly 20 of the depicted embodiment is configured as a single-speed motor.

As is somewhat conventional in the art, the winding 34 comprises a phase winding for each of the three power phases, as will be readily appreciated by one of ordinary skill in the art. For the sake of brevity, it is briefly noted that winding configurations for three-phase motors are generally known in the art and need not be described in detail herein. With reference to FIG. 1, in the depicted embodiment of the present invention, the stator assembly 28 includes a power connector 44 that includes three leads to be connected to a power source (not shown), with one of each of the leads corresponding to each of the three power phases.

Unconventionally, the winding 34 of the line-start brushless permanent magnet motor assembly 20 comprises aluminum, as described further below. More specifically, while the winding 34 comprising aluminum may also include other materials (e.g., aluminum alloys or copper-cladded aluminum), the winding 34 of the illustrated embodiment consists essentially of aluminum wire. Additional details and unforeseen advantages of this atypical winding material within the line-start brushless permanent magnet motor assembly 20 will be described in further detail below.

Turning next to construction details of the rotor assembly 24, and with specific reference to FIG. 2, the rotor assembly 24 broadly includes a rotor core body 46 comprising a plurality of axially stacked rotor laminations 48 integrally formed (such as by die casting) with a plurality of aluminum bars 50. The bars extend axially along the plurality of rotor laminations 48 and may include aluminum rings (not shown) disposed along respective axial margins thereof. As will be readily appreciated by one of ordinary skill in the art, the particular configuration of the bars 50 may directly impact startup operation of the motor assembly 20. It is noted that generally conventional configurations of bars, including but not limited to bars that skew helically around the rotor core body 46 or bars that have no skew at all, are contemplated and are clearly within the ambit of the present invention.

With continued reference to FIG. 2, each individual rotor lamination 48 includes a substantially annular steel body, such that the plurality of axially stacked rotor laminations 48 forming the rotor core body 46 cooperatively presents a radially outer periphery 52 and an axially aligned shaft hole 54 extending axially therethrough to receive the shaft 30. Additionally, the plurality of axially stacked rotor laminations 48 forming the rotor core body 46 further cooperatively presents a plurality of a generally arcuate slots 56 extending axially therethrough, with each slot 56 being disposed at least adjacent (if not in communication with) the radially outer periphery 52. As is generally known in the art, the aluminum bars 50 are formed to pass through the slots 56 to be disposed at least adjacent the radially outer periphery 52 of the rotor core body 46 to cooperatively define at least a portion thereof (if not cooperatively forming an exposed bar a rotor body). It is noted that in the illustrated embodiment, each rotor lamination 48 includes thirty-four slots 56, although various numbers of slots may be similarly provided without departing from the teachings of the present invention.

The rotor assembly 24 further includes a plurality of permanent magnets 58 mounted on the rotor core body 46, with the permanent magnets 58 extending generally axially along the rotor core body 46. In the illustrated embodiment, the permanent magnets 58 are received within generally elongated openings 60 cooperatively defined within the plurality of rotor laminations 48 of the rotor core body 46. At least one of the rotor laminations 48 is disposed in contact with each of the plurality of permanent magnets 58 to retain the permanent magnets 58 in place within the rotor core body 46.

In more detail, and with attention still on FIG. 2, each of the plurality of permanent magnets 58 is disposed generally parallel to the axis 26. Furthermore, each of the plurality of permanent magnets 58 is disposed substantially adjacent the radially outer periphery 52 of the rotor core body 46. While the permanent magnets 58 mounted on the rotor core body 46 may be present in various numbers and configurations (not shown), as will be readily appreciated by one of ordinary skill in the art, one particularly advantageous configuration is depicted in the drawings.

In the illustrated configuration, the rotor assembly 24 includes four permanent magnets 58, with each of the permanent magnets 58 being of substantially equal size. As can be seen in the sectional view of FIG. 2, the four permanent magnets 58 are arranged across a section of the rotor core body 46 in two pairs, with each of the pairs of permanent magnets 58 being generally symmetrical to the other of the pairs of permanent magnets 58 with respect to the axis 26. In the depicted embodiment, each of the permanent magnets 58 of the line-start brushless permanent magnet motor assembly 20 comprises neodymium.

Turning briefly now to electric motor efficiency, it may be readily appreciated by one of ordinary skill in the art that an energy cost associated with the operation of an electric motor over the lifetime of the motor can amount to a significant financial burden for an end user. Thus, an improvement in overall motor efficiency, even if such an improvement is only a relatively small percentage, can result in significant savings in energy costs over the lifetime of the motor. An inventive improvement to motor design or construction resulting in an efficiency gain, therefore, may provide significant competitive advantage.

Against the efficiency backdrop above, it is noted that in embodiments of the present invention, the unconventional combination within the line-start brushless permanent magnet motor assembly 20 of the rotor assembly 24 including the plurality of permanent magnets 58, and the stator assembly 28 including the winding 34 formed of aluminum, yields significant motor performance enhancements at considerably lower incremental cost than has been realized by prior art line-start brushless permanent magnet motors. These performance enhancements were unexpected to one of ordinary skill in the art.

More specifically, a winding formed of aluminum (which is a less expensive material than copper from which to construct a winding) has historically corresponded with a relatively significant loss in overall motor efficiency compared with a winding formed of copper. For example, from previous testing it was observed that in a prior art embodiment of an induction motor, a transition from a winding formed of copper to a winding formed of aluminum resulted in a relatively significant loss in overall motor efficiency of approximately 2% (efficiency dropped from approximately 91% to approximately 89%).

As will be readily appreciated by one of ordinary skill in the art, the correspondence between high efficiency and high cost has made traditional line-start brushless permanent magnet motors a premium category of motors, designed with maximum performance in mind. It is generally known that the permanent magnets add significant material cost to an otherwise typical induction motor. Conventional design, therefore, of prior art line-start brushless permanent magnet motors has consistently taught that the high-cost, high-grade permanent magnets of the rotor be paired with correspondingly high-cost, high-grade copper windings of the stator.

In the case of the present invention, however, it has been unexpectedly determined that the unique line-start brushless permanent magnet motor assembly 20 with the winding 34 formed of aluminum (a material not ordinarily used in windings for high-performance motors) exhibited only a slight performance difference compared to a prior art line-start brushless permanent magnet motor with copper windings. For example, it was observed that, as opposed to an efficiency drop relatively consistent with that exhibited in the induction motor testing above, the counterintuitive combination of the present invention results in a relatively small loss in overall motor efficiency of approximately only one-half of the loss observed in the induction motor testing described above. More specifically, the unique line-start brushless permanent magnet motor assembly 20 with the winding 34 formed of aluminum exhibited a loss in overall motor efficiency of only approximately 1% (efficiency dropped from approximately 95% to approximately 94%).

Moreover, the aluminum material used for the winding 34 of the new line-start brushless permanent magnet motor assembly 20 offsets a considerable portion of the material cost of the permanent magnets 58. In one embodiment, as referenced above, the new line-start brushless permanent magnet motor assembly 20 with the winding 34 formed of aluminum was constructed for a lower incremental cost than would have been the case had the winding been formed of copper, and the lower-cost motor assembly 20 demonstrated a motor efficiency of approximately 94%.

Turning now to FIGS. 3-4, the line-start brushless permanent magnet motor assembly 20 is depicted as part of the compressor assembly 22. While the compressor assembly 22 depicted and described herein takes the form of a hermetic digital scroll compressor, it is noted that the motor assembly 20 could be alternatively included in other applications, such as other types of compressor assemblies (e.g., fixed capacity) without departing from the teachings of the present invention.

It is initially noted that many aspects of the depicted compressor assembly 22 are generally conventional in the art and, therefore, will be described herein only relatively briefly. Nevertheless, it will be appreciated that various structural details of the compressor assembly 22 will be readily understood by one of ordinary skill in the art upon review of this disclosure.

With attention first to FIG. 3, it will be readily understood that many components of the compressor assembly 22 are contained within an internal chamber 62 that is broadly defined by a case in the form of a housing 64. In the depicted embodiment, the housing 64 is substantially sealed such that the internal chamber 62 is hermetically sealed from an outside environment. The illustrated housing 64 is generally cylindrical and presents opposite top and bottom axial margins 66, 68. The housing 64 comprises a shell element 70, a base 72 disposed generally adjacent the bottom margin 68, and a cap 74 disposed generally adjacent the top margin 66.

As will be readily appreciated by one of ordinary skill in the art, while the internal chamber 62 is hermetically sealed from an outside environment, some elements (e.g., electrical power and a working fluid to be compressed) must pass through the housing 64 through specific sealed passageways. In this regard, the compressor assembly 22 includes a compressor power connector 76 disposed on the shell element 70. As will be readily appreciated, the compressor power connector 76 is in electrical communication with the stator power connector 44 described above.

Furthermore, the compressor assembly 22 includes an inlet 78 disposed on the shell element 70, and an outlet 80 disposed on the cap 74 to transport compressible working fluid (e.g., coolant in liquid or gas phase) into and out of the internal chamber 62 of the compressor assembly 22. It will, of course, be readily understood that the specific dispositions of the inlet 78 and the outlet 80 could be altered without departing from the teachings of the present invention.

With attention now to FIG. 4, the compressor assembly 22 broadly includes a compressing mechanism 82 configured to provide variable capacity modulation, and a driving mechanism 84 including the motor assembly 20 described in detail above. The compressor assembly 22 further includes an upper bearing assembly 86 and a lower bearing assembly 88 for rotatably supporting the shaft 30 of the motor assembly 20 and components of the compressing mechanism 84.

The compressing mechanism 82 includes first and second mechanical elements, depicted in the form of scroll members 90, 92 that cooperate to compress a working fluid. In the illustrated embodiment, the first scroll member 90 is rotatably fixed relative to the second scroll member 92. The first scroll member 90 is also axially shiftably secured relative to the second scroll member 92 within the internal chamber 62 in a manner generally known in the art. The second scroll member 92 is operably coupled with the driving mechanism 84 to be drivingly connected to the shaft 30 of the motor assembly 20 via a crankpin 94 and a drive bushing 96, such that the second scroll member 92 is orbitally moveable relative to the first scroll member 90, as described in detail below.

The non-orbiting scroll member 90 and the orbiting scroll member 92 are positioned in meshing engagement with one another, and a suitable conventional coupling permits generally eccentric orbital motion (along an annular path) therebetween, but prevents relative spinning motion therebetween. A partition plate 98 is provided generally adjacent the top margin 66 of the housing 64 and serves to divide the internal chamber 62 into a discharge chamber 100 at the upper end thereof and a suction chamber 102 at the lower end thereof, as will be readily appreciated by one of ordinary skill in the art upon review of this disclosure.

As will be readily understood by one of ordinary skill in the art, when the first non-orbiting scroll member 90 and the second orbiting scroll member 92 are shifted axially relative to one another into a first position corresponding with a loaded state, the compressing mechanism 82 is configured to compress a working fluid and run at full (100%) capacity during rotation of the motor assembly 20 of the driving mechanism 84. Alternatively, when the first non-orbiting scroll member 90 and the second orbiting scroll member 92 are shifted axially relative to one another into a second position corresponding with an unloaded state, the compressing mechanism 82 is configured to not compress the working fluid and run at no (0%) capacity, even during continued rotation of the motor assembly 20 of the driving mechanism 84. In this way, the capacity of the digital scroll compressor assembly 22 can be changed quickly and efficiently without necessarily altering the speed of the motor assembly 20 of the driving mechanism 84.

The relative axial disposition between the first non-orbiting scroll member 90 and the second orbiting scroll member 92 may be operably shifted via a control (not shown), such as a solenoid valve, as is generally known in the art. Therefore, by appropriately varying the loaded state time and the unloaded state time during any given cycle time, the digital scroll compressor assembly 22 can deliver any capacity desired for a given system, as will be readily understood by one of ordinary skill in the art upon review of this disclosure.

During operation at full (100%) capacity, as the second orbiting scroll member 92 orbits with respect to the first non-orbiting scroll member 90, working fluid to be compressed is drawn into the suction chamber 102 of the internal chamber 62 of the compressor assembly 22 via the inlet 78. From the suction chamber 102, the working fluid moves into a volume-decreasing compression chamber 104 cooperatively defined by portions of the scroll members 90, 92. The intermeshing scroll wraps of the scroll members 90, 92 define moving pockets of working fluid within the compression chamber 104 that progressively decrease in size as they move radially inwardly as a result of the orbiting motion of the second orbiting scroll member 92, thus compressing the working fluid entering via inlet 78. The compressed working fluid is then discharged into the discharge chamber 100 and out of the compressor assembly 22 via the outlet 80.

During operation at no (0%) capacity, even if the second orbiting scroll member 92 orbits with respect to the first non-orbiting scroll member 90, the scroll members 90, 92 are shifted axially away from one another into the unloaded state, such that no suction is generated by the compression chamber 104 and there is no mass flow of the working fluid through the compressor assembly 22. Because the digital compressor assembly 22 can run at no (0%) capacity even as the second orbiting scroll member 92 is moving with respect to the first non-orbiting scroll member 90, the compressing mechanism 82 can effectively and efficiently be driven by the driving mechanism 84 including the line-start brushless permanent magnet motor assembly 20 configured as a single-speed motor, as described in detail above.

As also described in detail above, one embodiment of the new line-start brushless permanent magnet motor assembly 20 demonstrated a motor efficiency of approximately 94%. Since a motor assembly of a driving mechanism is often one of the highest power-consuming components of a compressor assembly (or even of an entire system incorporating the compressor assembly, such as an air conditioning system), the efficiency improvements provided by the new line-start brushless permanent magnet motor assembly 20 in the present invention provides significant performance enhancements in the compressor assembly 22. In one embodiment, the new digital compressor assembly 22 including the line-start brushless permanent magnet motor assembly 20, as described above, demonstrated a higher seasonal efficiency energy rating than has been achieved by prior art compressor assemblies.

As will be readily appreciated by one of ordinary skill in the art upon review of this disclosure, many of the above-described general components of the compressor assembly 22 are substantially conventional in nature, and various aspects of such components may take alternative forms and/or otherwise vary significantly from the illustrated embodiment without departing from the teachings of the present invention. Any such modifications to generally conventional components of the compressor assembly 22 are not intended to impact the scope of the present invention, which is defined exclusively by the claims.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A line-start brushless permanent magnet motor assembly comprising:
a rotor assembly rotatable about an axis,
said rotor assembly including a rotor core body and a plurality of permanent magnets mounted on the rotor core body,
said permanent magnets extending generally axially along the rotor core body; and
a stator assembly spaced radially away from the rotor assembly,
said stator assembly including a stator core body presenting a plurality of circumferentially spaced axial slots and defining a central bore for receiving the rotor assembly,
said stator assembly further including electrically conductive winding coils received within and distributed generally across multiple ones of the axial slots of the stator core body,
said winding coils comprising aluminum.

2. The line-start brushless permanent magnet motor assembly as claimed in claim 1,
said permanent magnets being received within the rotor core body,
said rotor core body comprising a plurality of axially stacked rotor laminations,
at least one of said rotor laminations being disposed in contact with the plurality of permanent magnets to retain the same in place.

3. The line-start brushless permanent magnet motor assembly as claimed in claim 2,
said permanent magnets being disposed generally parallel to the axis.

4. The line-start brushless permanent magnet motor assembly as claimed in claim 3,
said permanent magnets being disposed substantially adjacent a radially outer periphery of the rotor core body.

5. The line-start brushless permanent magnet motor assembly as claimed in claim 4,
said rotor assembly further including a plurality of circumferentially spaced axial bars disposed adjacent the radially outer periphery of the rotor core body to cooperatively define at least a portion thereof.

6. The line-start brushless permanent magnet motor assembly as claimed in claim 5,
said rotor assembly including four substantially equally-sized permanent magnets,
said permanent magnets being arranged in two pairs, with each of the pairs of magnets being symmetrical to the other of the pairs of magnets with respect to the axis.

7. The line-start brushless permanent magnet motor assembly as claimed in claim 6,
said motor assembly having an efficiency of at least about 90%.

8. The line-start brushless permanent magnet motor assembly as claimed in claim 7,
said motor assembly having an efficiency of at least about 94%.

9. The line-start brushless permanent magnet motor assembly as claimed in claim 1,
said motor assembly defining a three-phase motor.

10. The line-start brushless permanent magnet motor assembly as claimed in claim 1,
said motor assembly being disposed within a hermetic compressor, such that the rotor assembly and the stator assembly are housed within a compressor case to be hermetically sealed from an outside environment.

11. The line-start brushless permanent magnet motor assembly as claimed in claim 1,
said winding coils consisting essentially entirely of aluminum.

12. The line-start brushless permanent magnet motor assembly as claimed in claim 1,
said permanent magnets comprising neodymium.

13. In a line-start brushless permanent magnet motor assembly including a rotor rotatable about an axis and a stator spaced radially away from the rotor, with the stator presenting a plurality of circumferentially spaced axial slots for receiving winding coils and defining a central bore for receiving the rotor, wherein the improvement comprises combining a plurality of permanent magnets disposed within the rotor with the winding coils of the stator comprising aluminum,
said permanent magnets extending generally axially along the rotor to be disposed generally parallel to the axis,
said aluminum winding coils being received within and distributed generally across multiple ones of the axial slots of the stator core body.

14. In the line-start brushless permanent magnet motor assembly as claimed in claim 13,
said permanent magnets comprising neodymium,
said winding coils consisting essentially entirely of aluminum.

15. In the line-start brushless permanent magnet motor assembly as claimed in claim 14,
said motor assembly having an efficiency of at least about 90%.

16. In the line-start brushless permanent magnet motor assembly as claimed in claim 15,
said rotor including four substantially equally-sized permanent magnets,
said permanent magnets being arranged in two pairs, with each of the pairs of magnets being symmetrical to the other of the pairs of magnets with respect to the axis.

17. A method of delivering increased motor efficiency at lower incremental cost, said method comprising the steps of:
(a) providing a plurality of permanent magnets within a rotor,
said permanent magnets extending generally axially along the rotor,
(b) forming winding coils from aluminum for receipt within a plurality of circumferentially spaced axial slots of a stator; and
(c) disposing the rotor within a central bore of the stator to form an aluminum wound, line-start, brushless, permanent magnet motor, wherein said motor has an efficiency of at least about 90%.

18. The motor efficiency delivering method of claim 17,
step (a) including the step of including four substantially equally-sized permanent magnets within the rotor,
said permanent magnets being arranged in two pairs, with each of the pairs of magnets being symmetrical to the other of the pairs of magnets with respect to the axis.

19. The motor efficiency delivering method of claim 17,
step (b) including the step of forming the winding coils essentially entirely from aluminum.

20. The motor efficiency delivering method of claim 17; and
(d) incorporating said motor into a hermetic compressor, such that the motor is housed within a compressor case to be hermetically sealed from an outside environment.
